(19) United States
(12) Patent Application Publication
(10) Pub. No.: US 2020/0274678 A1
(43) Pub. Date: Aug. 27, 2020

(54) Data Transmission Method, Terminal Device, and Network Device

(71) Applicant: GUANGDONG OPPO MOBILE TELECOMMUNICATIONS CORP., LTD., Dongguan, Guangdong (CN)

(72) Inventors: Yanan Lin, Dongguan, Guangdong (CN); Jia Shen, Dongguan, Guangdong (CN)

(21) Appl. No.: 16/761,580

(22) PCT Filed: Nov. 16, 2017
(86) PCT No.: PCT/CN2017/111463

§ 371 Date: May 5, 2020

(51) Int. Cl. H04L 5/00; H04W 72/10; H04W 72/04; H04W 72/12

(52) U.S. Cl. CPC H04L 5/0092; H04W 72/10; H04W 72/1257; H04W 72/0413; H04W 72/0453

(57) ABSTRACT

Implementations of the present disclosure disclose a data transmission method, a terminal device, and a network device. The method comprises: the terminal device determines a target bandwidth part (BWP) according to at least one of BWP indication information, a BWP timer, and a BWP priority; and the terminal device transmits data on the target BWP.

### TECHNICAL FIELD

Embodiments of the present application relate to the field of communication, and more specifically to a method for transmitting data, a terminal device, and a network device.

### BACKGROUND

In a discussion of a 5G New Radio (NR) system, it is determined that a system bandwidth supported by a NR system is much larger than that of a Long Term Evolution (LTE) system. However, for some terminal devices, due to limited capabilities thereof, they cannot support all system bandwidths. Therefore, a concept of Bandwidth Part (BWP) is introduced into the NR system. A network device may configure one or more BWPs for a terminal device, and a bandwidth of each BWP is less than or equal to a maximum system bandwidth.

The network device may, through Downlink Control Information (DCI), activate or deactivate configuration of the BWP. The network device may configure a BWP timer, and when the BWP timer expires, it falls back to a default BWP.

However, when multiple BWPs are all before the timer expires, how to determine configuration of the BWPs for data transmission is an urgent problem to be solved.

### SUMMARY

Embodiments of the application provide a method for transmitting data, a terminal device, and a network device, which solves a switching problem when multiple BWPs coexist.

In a first aspect, a method for transmitting data is provided, including: determining, by a terminal device, a target Bandwidth Part (BWP) according to at least one of BWP indication information, a BWP timer, and a BWP priority; and transmitting, by the terminal device, data on the target BWP.

Optionally, the BWP timer in embodiment of the present application may be determined by setting a starting effective time and an effective duration of a BWP, or may be determined by setting a starting effective time and an expiration time.

In combination with the first aspect, in some possible implementations of the first aspect, determining, by the terminal device, the target BWP according to at least one of a BWP indication, the BWP timer, and the BWP priority, includes: determining, by the terminal device, a BWP with a higher priority as the target BWP.

Therefore, in the method for transmitting the data according to the embodiment of the present application, when multiple BWPs take effect at the same time, the terminal device may select the BWP with a higher priority for data transmission, which is beneficial to avoiding a problem of low transmission efficiency caused by not knowing, by the terminal device, which BWP to perform data transmission on.

In combination with the first aspect, in some possible implementations of the first aspect, the BWP priority is determined by at least one of signaling configuration and a receiving order of the BWP indication information and priority configuration of a channel in which the BWP indication information is located.

In combination with the first aspect, in some possible implementations of the first aspect, a default BWP has a lowest priority.

In combination with the first aspect, in some possible implementations of the first aspect, configuration of the BWP timer includes at least one of a specific time length, a specific time pattern, a data transmission duration, and an infinite duration. Therefore, the terminal device may set different durations of BWP timers according to requirements of different scenarios, and thus transmission requirements of the different scenarios can be met.

In combination with the first aspect, in some possible implementations of the first aspect, the data transmission duration is a duration of one time of data transmission or a duration of semi-persistent scheduling.

For example, for the semi-persistent scheduling, the data transmission duration may be a duration of the semi-persistent scheduling, wherein the duration of the semi-persistent scheduling may be a duration from a starting time point to an ending time point of the semi-persistent scheduling, or a duration, for semi-persistent scheduling transmission, during a period of from a starting time point to an ending time point of the semi-persistent scheduling. For dynamic scheduling, a duration of a BWP may be a data transmission duration of the dynamic scheduling.

In combination with the first aspect, in some possible implementations of the first aspect, the BWP timer is exclusive to a BWP or independently configured.

In combination with the first aspect, in some possible implementations of the first aspect, the BWP timer is determined by at least one of a state of BWP configuration and a scheduling type.

For example, for semi-persistent scheduling, a duration of the BWP timer may be equal to a duration of the semi-persistent scheduling. Or, for dynamic scheduling, a duration of the BWP timer may be a data transmission duration, or may be an effective period of a BWP configured semi-statically.

In combination with the first aspect, in some possible implementations of the first aspect, a state of the BWP configuration is used for indicating a number of BWPs which take effect at the same time.

In combination with the first aspect, in some implementations of the first aspect, the method further includes: receiving, by the terminal device, at least one kind of configuration information in the Bandwidth Part (BWP) indication information, the BWP timer, and the BWP priority.

In a second aspect, a method for transmitting data is provided, including: determining, by a network device, a target Bandwidth Part (BWP) according to at least one of BWP indication information, a BWP timer, and a BWP priority; and receiving, by the network device, data on the target BWP.

In combination with the second aspect, in some possible implementations of the second aspect, determining, by the network device, the target Bandwidth Part (BWP) according to at least one of a BWP indication, the BWP timer, and the BWP priority, includes: determining, by the network device, a BWP with a higher priority as the target BWP.

In combination with the second aspect, in some possible implementations of the second aspect, the BWP priority is determined by at least one of signaling configuration and a receiving order of the BWP indication information and priority configuration of a channel in which the BWP indication information is located.

In combination with the second aspect, in some possible implementations of the second aspect, a default BWP has a lowest priority.

In combination with the second aspect, in some possible implementations of the second aspect, configuration of the BWP timer includes at least one of a specific time length, a specific time pattern, a data transmission duration, and an infinite duration.

In combination with the second aspect, in some possible implementations of the second aspect, the data transmission duration is a duration of one time of data transmission or a duration of semi-persistent scheduling.

In combination with the second aspect, in some possible implementations of the second aspect, the BWP timer is exclusive to a BWP or independently configured.

In combination with the second aspect, in some possible implementations of the second aspect, the BWP timer is determined by at least one of a state of BWP configuration and a scheduling type.

In combination with the second aspect, in some possible implementations of the second aspect, a state of the BWP configuration is used for indicating a number of BWPs which take effect at the same time.

In combination with the second aspect, in some possible implementations of the second aspect, the method further includes: sending, by the network device, at least one kind of configuration information in the Bandwidth Part (BWP) indication information, the BWP timer, and the BWP priority to a terminal device.

In a third aspect, a terminal device is provided, which is used for performing the method in the first aspect or any possible implementation of the first aspect. Specifically, the terminal device includes units for performing the method of the first aspect or the method in any possible implementation of the first aspect.

In a fourth aspect, a terminal device is provided, including a memory, a processor, an input interface, and an output interface. The memory, the processor, the input interface, and the output interface are connected through a bus system. The memory is used for storing instructions, and the processor is used for executing the instructions stored in the memory for executing the method of the first aspect or any one of the possible implementations of the first aspect.

In a fifth aspect, a network device is provided for executing the method in the second aspect or any possible implementation of the second aspect. Specifically, the network device includes units for performing the method of the second aspect or the method in any possible implementation of the second aspect.

In a sixth aspect, a network device is provided. The network device includes a memory, a processor, an input interface, and an output interface. The memory, the processor, the input interface, and the output interface are connected through a bus system. The memory is used for storing instructions, and the processor is used for executing the instructions stored in the memory for executing the method of the second aspect or any one of the possible implementations of the second aspect.

In a seventh aspect, a computer storage medium is provided for storing computer software instructions for executing the method of the first aspect or any possible implementation of the first aspect, and the computer software instructions include programs designed for executing the aspect.

In an eighth aspect, a computer program product containing instructions is provided, when the instructions are executed on a computer, the computer is caused to perform the method of the first aspect or any one of optional implementations of the first aspect.

In a ninth aspect, a computer storage medium is provided for storing computer software instructions for executing the method of the second aspect or any possible implementation of the second aspect, and the computer software instructions include programs designed for executing the aspect.

In a tenth aspect, a computer program product containing instructions is provided, when the instructions are executed on a computer, the computer is caused to perform the method of the second aspect or any one of optional implementations of the second aspect.

### BRIEF DESCRIPTION OF DRAWINGS

FIG. 1 shows a diagram of an application scenario according to an embodiment of the present application.

FIG. 2 is a schematic flowchart of a method for transmitting data according to an embodiment of the present application.

FIG. 3 shows a schematic diagram of a mode for determining a duration of a BWP timer.

FIG. 4 shows a schematic diagram of another mode for determining a duration of a BWP timer.

FIG. 5 shows a schematic diagram of yet another mode for determining a duration of a BWP timer.

FIG. 6 shows a schematic diagram of yet another mode for determining a duration of a BWP timer.

FIG. 7 shows a schematic diagram of yet another mode for determining a duration of a BWP timer.

FIG. 8 shows a schematic diagram of yet another mode for determining a duration of a BWP timer.

FIG. 9 is a schematic flowchart of a method for transmitting data according to another embodiment of the present application.

FIG. 10 shows a block diagram of a terminal device according to an embodiment of the present application.

FIG. 11 shows a schematic block diagram of a network device according to another embodiment of the present application.

FIG. 12 shows a block diagram of a terminal device according to an embodiment of the present application.

FIG. 13 shows a schematic block diagram of a network device according to another embodiment of the present application.

### DETAILED DESCRIPTION

Hereinafter, technical solutions in embodiments of the present application will be described with reference to accompanying drawings.

The technical solutions of the embodiments of the present application may be applied to various communication systems, such as a Long Term Evolution (LTE) system, an LTE Frequency Division Duplex (FDD) system, an LTE Time Division Duplex (TDD) system, or a future 5G system.

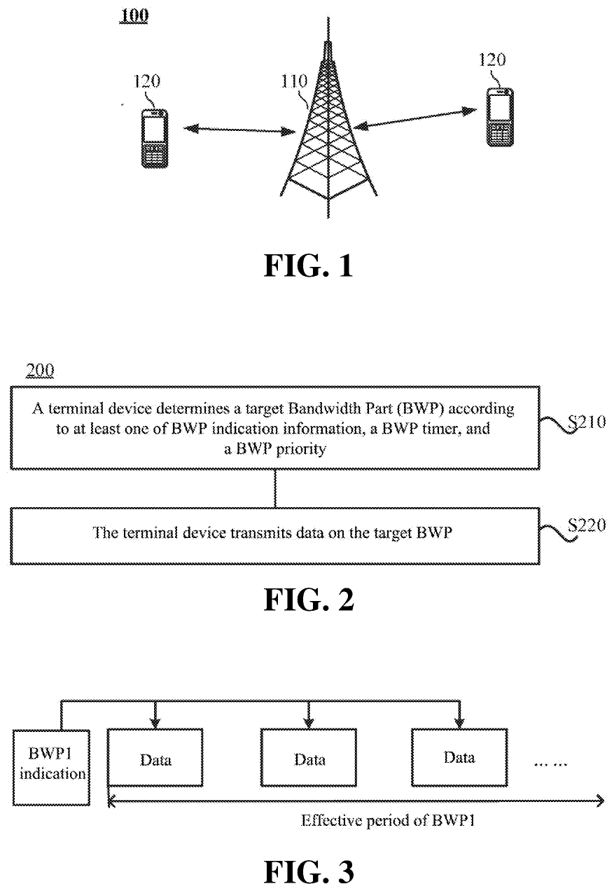

FIG. 1 shows a wireless communication system 100 to which an embodiment of the present application is applied. The wireless communication system 100 may include a network device 110. The network device 100 may be a device that communicates with a terminal device.

The network device 100 may provide communication coverage for a specific geographical area, and may communicate with a terminal device (e.g., UE) in the coverage area. Optionally, the network device 100 may be an Evolutional Node B (eNB or eNodeB) in an LTE system, or the network device may be a relay station, an access point, an on-board device, a wearable device, a network-side device in a future 5G network, or a network device in a future evolved Public Land Mobile Network (PLMN), etc.

The wireless communication system 100 further includes at least one terminal device 120 in the coverage area of the network device 110. The terminal device 120 may be mobile or fixed. Optionally, the terminal device 120 may be referred to as an access terminal, a User Equipment (UE), a subscriber unit, a subscriber station, a mobile station, a mobile platform, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device, or other processing device connected to a wireless modem, a vehicle-mounted device, a wearable device, a terminal device in a future 5G network, or a terminal device in a future evolved Public Land Mobile Network (PLMN), or the like.

In the embodiment of the present application, a BWP configured by a network device to a terminal device may include at least one of following parameters: 1. a basic parameter set, wherein the basic parameter set is used for identifying a carrier interval; 2. a central frequency point; and 3. a bandwidth, wherein the bandwidth is less than or equal to a maximum system bandwidth.

Thus it can be seen that, the BWP is a concept of a frequency domain dimension, and the terminal device may support one activated BWP at a time point, that is, the terminal device expects to transmit data on a bandwidth specified by the activated BWP, such as to transmit a control signaling, uplink and downlink data, or to receive a system message, or the like.

As mentioned above, the network device may activate or deactivate a BWP through DCI, or may configure a BWP timer. If a BWP timer corresponding to a BWP expires after the BWP is configured to be activated, then it falls back onto a default BWP for data transmission.

However, in some scenarios, if none of BWP timers of multiple BWPs expire, that is, the multiple BWPs are all within effective periods, then a terminal device or a network device does not know on which BWP data is received.

In view of this, an embodiment of the present application provides a method for transmitting data, so that a terminal device or a network device can learn on which BWP to perform data receiving.

FIG. 2 is a schematic flowchart of a method 200 for transmitting data according to an embodiment of the present application, wherein the method 200 may be performed by a terminal device in the communication system 100 shown in FIG. 1. As shown in FIG. 2, the method 200 may include acts S210 and S220.

In S210, a terminal device determines a target Bandwidth Part (BWP) according to at least one of BWP indication information, a BWP timer, and a BWP priority.

In S220, the terminal device transmits data on the target BWP.

It should be understood that the BWP timer in the embodiment of the present application may be determined by setting a starting effective time and an effective duration of a BWP, or may be determined by setting a starting effective time and an expiration time. When the BWP timer does not expire, the BWP corresponding to the BWP timer is within an effective period, that is, data transmission may be performed on the BWP. When the BWP timer expires, the BWP corresponding to the BWP timer fails, then data transmission cannot be performed on the BWP.

Specifically, at a current time point, if at least one BWP is in an activated state, that is, at least one BWP is within an effective period, in this case, the terminal device may determine on which BWP to currently perform data transmission, that is, determine a target BWP for performing data transmission, according to one or more of received downlink control information (Grant) including a BWP indication, a BWP timer, and a BWP priority, and then perform data transmission on the target BWP.

For example, if a first BWP is currently in an activated state, and then the terminal device receives indication information for activating a second BWP, then the terminal device may determine the second BWP as the target BWP and perform data transmission on the second BWP. Or if both a first BWP and a second BWP are currently in activated states, if a priority of the second BWP is higher than a priority of the first BWP, then the terminal device may determine the second BWP as the target BWP, and then preferentially perform data transmission on the second BWP. After the data transmission on the second BWP is completed, if a BWP timer corresponding to the first BWP has not expired, then the terminal device may switch back to the first BWP and continue to perform data transmission on the first BWP, or if a BWP timer of the first BWP has expired and no other BWP is in an activated state, then the terminal device may switch to a Default BWP for data transmission.

That is to say, when multiple BWPs are within effective periods, the terminal device preferentially determines on which BWP to perform data transmission according to the BWP priority. After completing to receive data on a BWP with a higher priority, the terminal device performs data receiving on a BWP with a lower priority. When all completing to transmit data on BWPs other than a default BWP, or when all corresponding BWP timers expire, the terminal device then falls back onto the default BWP for data transmission, i.e., the default BWP has a lowest priority.

It should be understood that the above only illustrates a mode in which a target BWP is determined according to at least one of BWP indication information, a BWP timer, and a BWP priority, and should not constitute any limitation to the embodiments of the present application. The embodiments of the present application may determine a target BWP according to other information, such as a service type of a service to be transmitted, etc., and the embodiments of the present application are not limited to this.

It needs be noted that, in the embodiment of the present application, in order to facilitate describing and distinguishing specific scenarios, one or more BWPs are within effective periods, refers to that one or more activated BWPs are within the effective periods, excluding a default BWP.

Optionally, in the embodiment of the present application, the BWP priority is determined by at least one of signaling configuration and a receiving order of BWP indication information and priority configuration of a channel in which the BWP indication information is located.

For example, the BWP priority may be configured by the network device through a signaling (e.g., a Radio Resource Control (RRC) signaling). If the network device configures BWP2 with a priority higher than that of BWP1, then the terminal device may preferentially perform data transmission on the BWP2 when both the BWP1 and the BWP2 are within effective periods.

Or, the BWP priority may be determined according to a receiving order of BWP indication information (i.e., Grant). For example, the terminal device may determine that a BWP included in a Grant latest received has a highest priority. Optionally, the terminal device may determine the BWP priority according to priority configuration of a channel for transmitting the BWP indication information, for example, the terminal device may determine the BWP priority according to at least one of a search space for transmitting the BWP indication information, a Physical Downlink Control Channel (PDCCH) format, a Control Resource Set (CORESET), and a scheduling type (semi-persistent scheduling, or dynamic scheduling), or the terminal device may determine the BWP priority according to other information, such as a service type of a service to be transmitted, etc., and the embodiments of the present application are not limited to this.

Therefore, in the method for transmitting the data according to the embodiment of the present application, when multiple BWPs take effect at the same time, the terminal device may select the BWP with a higher priority for data transmission, which is beneficial to avoiding a problem of low transmission efficiency caused by not knowing, by the terminal device, on which BWP to perform data transmission.

Optionally, in the embodiment of the present application, configuration of the BWP timer includes at least one of a specific time length, a specific time pattern, a data transmission duration, and an infinite duration.

Specifically, the terminal device may set different durations of BWP timers according to requirements of different scenarios, and thus transmission requirements of the different scenarios can be met. For example, for a scenario where BWPs are not frequently switched, a duration of a BWP timer may be a specific time length; for a scenario where BWP configuration is not changed, a duration of a BWP timer is an infinite duration, and thus receiving of BWP failure signaling may be avoided; or for a scenario where a dynamic service is transmitted on multiple BWPs, a duration of a BWP timer may be a data transmission duration, that is, a duration actually used for data transmission, etc.

It should be understood that information included in the configuration of the BWP timer described above is only an example and not a limitation, and the configuration of the BWP timer in the embodiments of the present application may include other information, which is not limited in the embodiments of the present application.

Optionally, in some embodiments, the BWP timer may be exclusive to a BWP or may be independently configured.

In other words, an exclusive BWP timer may be configured for each BWP, so that no additional signaling is required to configure a duration of a BWP timer corresponding to the each BWP, and when a BWP is activated, a BWP timer corresponding to the BWP is started; or, a corresponding BWP timer may be configured for each BWP through a signaling, wherein the signaling may be explicit or implicit. In the embodiment of the present application, the duration of the BWP timer corresponding to each BWP may be same or different. Specifically, a duration of each BWP timer may be one of a specific time length, a specific time pattern, a data transmission duration, and an infinite duration.

Hereinafter, a method for determining a BWP timer will be described in detail with reference to Embodiments 1 and 2.

Embodiment 1: a duration of a BWP timer is determined according to a scheduling type.

Embodiment 1.1: a duration of the BWP timer is determined according to a data transmission duration.

In this embodiment, the duration of the BWP timer may be the data transmission duration. For example, for semi-persistent scheduling, the data transmission duration may be a duration of the semi-persistent scheduling, wherein the duration of the semi-persistent scheduling may be a duration from a starting time point to an ending time point of the semi-persistent scheduling, or a duration, for semi-persistent scheduling transmission, during a period of from a starting time point to an ending time point of the semi-persistent scheduling. For dynamic scheduling, the duration of BWP may be a data transmission duration of the dynamic scheduling. Therefore, the BWP timer according to the embodiment of the present application may be determined according to the scheduling type and the data transmission duration, so that the BWP configuration can better match the data transmission requirement.

For example, FIG. 3 shows a semi-persistent scheduling scenario. At a time point, the terminal device receives downlink control information (denoted as Grant1) including a BWP1 indication, wherein the Grant1 is used for indicating the terminal device to perform data transmission on the BWP1, and the scheduling mode is the semi-persistent scheduling, then the duration of the BWP timer corresponding to the BWP1 is the duration of the semi-persistent scheduling, i.e. an effective period of the BWP1 is the duration of the semi-persistent scheduling. In a duration range of the semi-persistent scheduling, i.e. within the effective period of the BWP1, the terminal device may perform data transmission on the BWP1. For example, the semi-persistent scheduling has a starting time point of 0 ms, an ending time point of 30 ms, a scheduling period of 10 ms, and the duration of the semi-persistent scheduling within each scheduling period is 5 ms, then the duration of one time of data transmission may be 5 ms, and the duration of the semi-persistent scheduling may be 30 ms or 15 ms.

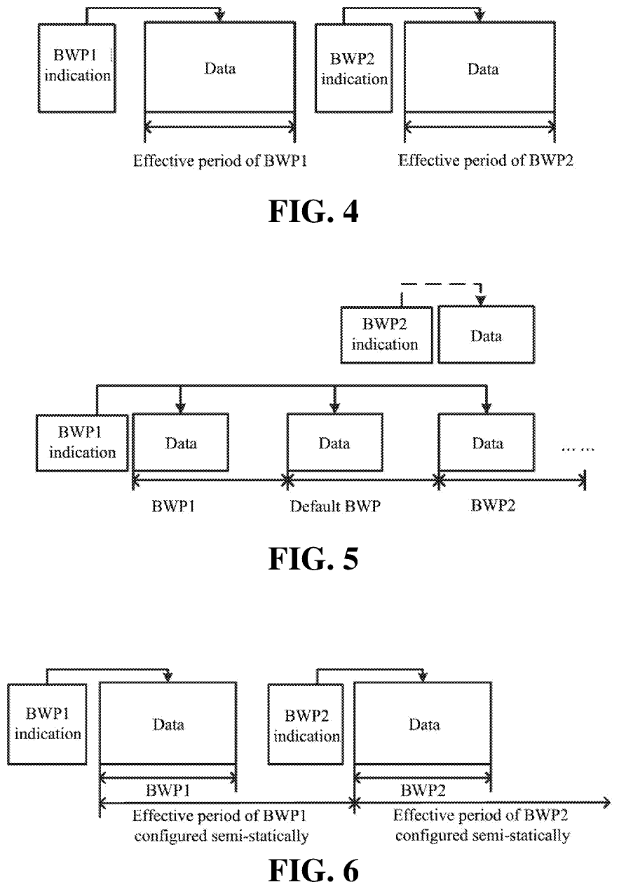

As shown in FIG. 4, a dynamic scheduling scenario is shown. At a time point, the terminal device receives downlink control information (denoted as Grant1) including a BWP1 indication, wherein the Grant1 is used for indicating the terminal device to perform data transmission on the BWP1, and the scheduling mode is the dynamic scheduling, then the duration of the BWP timer corresponding to the BWP1 may be the duration of the dynamic scheduling, i.e. a duration of data transmission on the BWP1. The BWP timer corresponding to the BWP1 expires, after the data transmission on the BWP1 is completed. After that, if the terminal device receives downlink control information (denoted as Grant2) including a BWP2 indication, wherein the Grant2 is used for indicating the terminal device to perform data transmission on the BWP2, and the scheduling mode is the dynamic scheduling, then the duration of BWP timer corresponding to the BWP2 is a duration of data transmission on the BWP2, and the BWP timer corresponding to the BWP2 expires after the data transmission on the BWP2 is completed.

Embodiment 1.2: the duration of the BWP timer is determined according to a data transmission duration and a duration of a BWP timer configured semi-statically.

The terminal device comprehensively considers the data transmission duration and the duration of the BWP timer configured semi-statically (or, in other words, an effective period of the BWP configured semi-statically), and determines the duration of the BWP timer, so that a granularity of BWP configuration is finer, and further a system efficiency can be improved. For example, the terminal device may determine that the duration of the BWP timer is a smaller value of the data transmission duration and the duration of the BWP timer configured semi-statically.

Specifically, for the semi-persistent scheduling, a time domain length of a resource used for the semi-persistent scheduling is generally longer (e.g., may be a time domain length of an entire connection state), and the duration of the BWP timer configured semi-statically is generally smaller than the time domain length of the resource for the semi-persistent scheduling, in which case, the time duration of the BWP timer may be the time duration of the BWP timer configured semi-statically.

For example, for a semi-persistent scheduling scenario shown in FIG. 5, at a time point, the terminal device receives downlink control information (denoted as Grant1) including a BWP1 indication, wherein the Grant1 is used for indicating the terminal device to perform data transmission on the BWP1, and the duration of the BWP timer of the BWP1 may be the duration of the BWP timer configured semi-statically. After the BWP timer corresponding to the BWP1 expires, the terminal device switches to a default BWP and performs data transmission on the default BWP, wherein a duration of a BWP timer of the default BWP may be unlimited. Until the terminal device receives a new Grant2, further, the terminal device performs data transmission on the BWP2 according to an indication of the Grant2, and a duration of a timer corresponding to the BWP2 may be the duration of the BWP timer configured semi-statically. That is, multiple independent BWP timers may be included in the semi-persistent scheduling.

For dynamic scheduling, a time domain length of the dynamic scheduling is usually smaller than the duration of the BWP timer configured semi-statically, that is, a smaller value of the time domain length of the dynamic scheduling and the duration of the BWP timer configured semi-statically is the time-domain length of the dynamic scheduling, so the terminal device may determine that the duration of the BWP timer may be the time domain length of the dynamic scheduling, that is, in the dynamic scheduling, each dynamic scheduling may correspond to an independent BWP timer.

For example, for a dynamic scheduling scenario shown in FIG. 6, at a time point, the terminal device receives downlink control information (denoted as Grant1) including a BWP1 indication, wherein the Grant1 is used for indicating the terminal device to perform data transmission on the BWP1, and the duration of the BWP timer corresponding to the BWP1 may be the duration of data transmission on the BWP1. After that, if the terminal device receives downlink control information (denoted as Grant2) including a BWP2 indication, wherein the Grant2 is used for indicating the terminal device to perform data transmission on the BWP2, then the duration of the BWP timer corresponding to the BWP2 is the duration of data transmission on the BWP2.

Synthesizing the Embodiment 1, the terminal device may determine a duration of a BWP timer corresponding to a BWP according to a scheduling type. For example, for semi-persistent scheduling, the duration of the BWP timer may be equal to a duration of the semi-persistent scheduling. Or, for dynamic scheduling, the duration of the BWP timer may be a data transmission duration, or may be an effective period of a BWP configured semi-statically.

Embodiment 2: a duration of a BWP timer is determined according to a state of BWP configuration.

Specifically, the state of the BWP configuration may be used for indicating a number of BWPs which take effect at the same time, where the number of the BWPs which take effect at the same time includes only the activated BWP, not a default BWP. For example, if only one BWP is currently in an effective state (denoted as state 1), the duration of the BWP timer of the BWP may be determined according to the mode described in embodiment 1, which will not be repeated here. Or if there are currently multiple BWPs in effective states (denoted as state 2), then the terminal device may determine the duration of the BWP timer corresponding to each BWP according to the BWP priority. For example, the terminal device may determine the duration of the BWP timer corresponding to a BWP with a higher priority as the data transmission duration, and determine the duration of a BWP with a low priority as the effective period of the BWP configured semi-statically. In this way, the terminal device may preferentially perform data transmission on a BWP with a higher priority, and after transmission is completed, if an effective period of a BWP with a low priority has not ended, then the terminal device may perform data transmission on the BWP with the low priority, otherwise, the terminal device falls back onto a default BWP for data transmission. Therefore, in a case that multiple BWPs take effect at the same time, flexible switching of BWPs may be realized and a system efficiency may be improved.

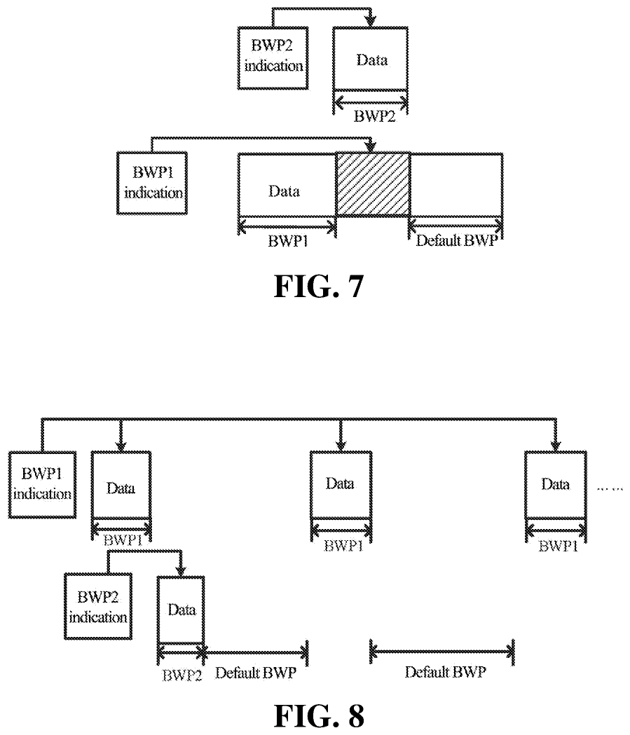

For example, in FIG. 7, at a time point, the terminal device receives downlink control information (denoted as Grant1) including a BWP1 indication, wherein the Grant1 is used for indicating the terminal device to perform data transmission on the BWP1. At this time, only the BWP1 is in the effective state (regardless of the default BWP) (corresponding to the state 1 described above), and the duration of the BWP timer corresponding to the BWP1 may be the effective period of the BWP1 configured semi-statically, or may be the data transmission duration. After that, the terminal device receives downlink control information (denoted as Grant2) including a BWP2 indication again, wherein the Grant2 is used for indicating the terminal device to perform data transmission on the BWP2. At this time, since the effective period of the BWP1 has not ended, i.e. both the BWP1 and the BWP2 are in the effective states (corresponding to the state 2 mentioned above), the terminal device determines, according to the BWP priority, that the priority of the BWP2 is higher than that of the BWP1, then the terminal device switches onto the BWP2 for data transmission, and the duration of the BWP timer corresponding to the BWP2 may be the duration of data transmission on the BWP2 (i.e., the duration of the shaded portion shown in FIG. 7). After transmission on the BWP2 is completed, if the BWP timer corresponding to the BWP1 has not expired, the terminal device then switches back to the BWP1 for data transmission, or if the BWP timer of the BWP1 has expired and there are no other BWPs in the activated states, the terminal device then switches back to the default BWP for data transmission.

In the example shown in FIG. 7, the duration of the BWP timer corresponding to the BWP1 may be configured to a specific time length, for example, the duration of a corresponding BWP timer may be determined according to the service type of BWP1 transmission. Assuming that the BWP timer corresponding to the BWP1 has a duration of 20 ms, the BWP timer corresponding to the BWP2 has a duration of one time of data transmission. Then when the terminal device receives the downlink control information including the BWP1 indication, the terminal device may receive data within a duration range of the BWP timer corresponding to the BWP1. If the terminal device receives downlink control information including a BWP2 indication again within the duration range of the BWP timer corresponding to the BWP1, and the terminal device determines that the priority of the BWP2 is higher than the priority of the BWP1 according to the BWP priority, then the terminal device switches onto the BWP2 to receive data, with a duration of the duration of receiving data on the BWP2. After completing to receive data on the BWP2, the terminal device switches back to the BWP1 to continue data transmission on the BWP1 (provided that the BWP timer corresponding to the BWP1 does not expire, and if it expires, then the terminal device switches back to the default BWP).

FIG. 7 shows a dynamic scheduling scenario. In the following, how to perform data transmission when multiple BWP take effect at the same time will be described with reference to the semi-persistent scheduling scenario shown in FIG. 8.

In FIG. 8, at a time point, the terminal device receives downlink control information (denoted as Grant1) including a BWP1 indication, wherein the Grant1 is used for indicating the terminal device to perform data transmission on the BWP1. The scheduling mode of the BWP1 is semi-persistent scheduling, then the duration of the timer corresponding to the BWP1 is the data transmission duration, from the starting time point to the ending time point of the semi-persistent scheduling, or a time interval of all semi-persistent scheduling resources from the starting time point to the ending time point of the semi-persistent scheduling, or a time interval of the semi-persistent scheduling resource in which transmission occurs from the starting time point to the ending time point of the semi-persistent scheduling. After that, the terminal device receives downlink control information (denoted as Grant2) including a BWP2 indication again, wherein the Grant2 is used for indicating the terminal device to perform data transmission on the BWP2. The scheduling is the dynamic scheduling, then the duration of the timer corresponding to the BWP2 is a duration of one time of data transmission. The terminal device determines that the priority of the BWP2 is higher than the priority of the BWP1 according to the BWP priority, then the terminal device switches onto the BWP2 for data transmission, and after completing to receive data on the BWP2, switches back to the BWP1, and continues to receive data on the BWP1, thus avoiding signaling overhead caused by performing BWP switching by a signaling.

Optionally, in some embodiments, the method 200 further includes: the terminal device receives at least one kind of configuration information in the Bandwidth Part (BWP) indication information, the BWP timer, and the BWP priority.

That is, the network device may configure at least one of the BWP indication information, the BWP timer, and the BWP priority to the terminal device. For example, the network device may configure at least one of the above information through a dynamic signaling or a semi-static signaling. Optionally, the terminal device may receive other configuration information for determining the target BWP, which is not limited by the embodiments of the present application.

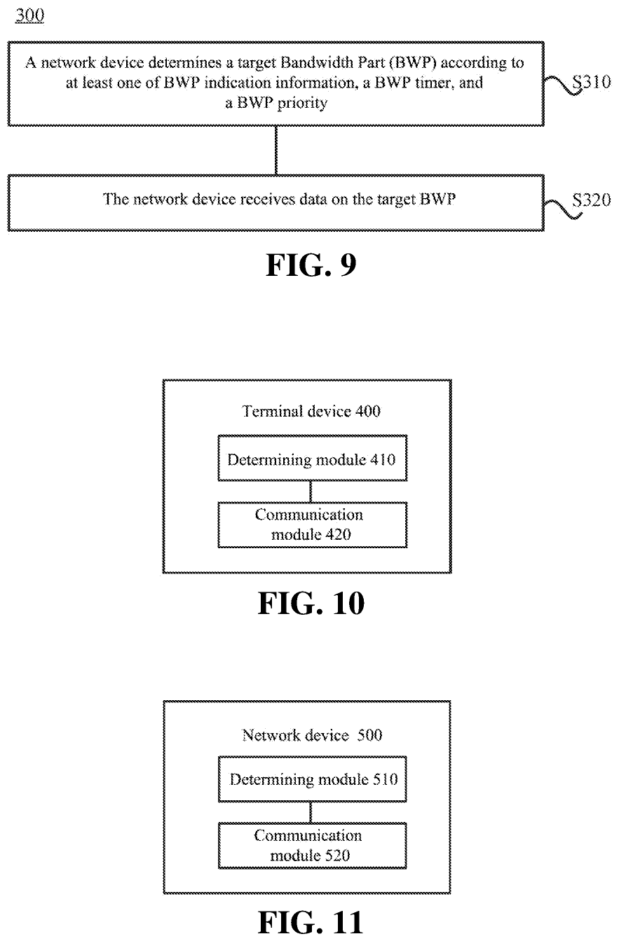

The method for transmitting the data according to the embodiments of the present application is described in detail from a perspective of the terminal device above in combination with FIGS. 2 to 8, and a method for transmitting data according to another embodiment of the present application is described in detail from a perspective of the network device below in combination with FIG. 9. It should be understood that actions of the network device side are similar to actions of the terminal device side, and similar descriptions may refer to the above text, which will not be repeated here to avoid repetition.

FIG. 9 is a schematic flowchart of a method 300 for transmitting data according to another embodiment of the present application, and the method 300 may be performed by the terminal device in the communication system shown in FIG. 1. As shown in FIG. 9, the method 300 includes acts S310 and S320.

In S310, a network device determines a target Bandwidth Part (BWP) according to at least one of BWP indication information, a BWP timer, and a BWP priority; and in S320, the network device receives data on the target BWP.

Optionally, in some embodiments, the network device determines the target Bandwidth Part (BWP) according to at least one of a BWP indication, the BWP timer, and the BWP priority, including: the network device determines a BWP with a higher priority as the target BWP.

Optionally, in some embodiments, the BWP priority is determined by at least one of signaling configuration and a receiving order of the BWP indication information and priority configuration of a channel in which the BWP indication information is located.

Optionally, in some embodiments, a default BWP has a lowest priority.

Optionally, in some embodiments, configuration of the BWP timer includes at least one of a specific time length, a specific time pattern, a data transmission duration, and an infinite duration.

Optionally, in some embodiments, the data transmission duration is a duration of one time of data transmission or a duration of semi-persistent scheduling.

Optionally, in some embodiments, the BWP timer is exclusive to a BWP or independently configured.

Optionally, in some embodiments, the BWP timer is determined by at least one of a state of BWP configuration and a scheduling type.

Optionally, in some embodiments, a state of the BWP configuration is used for indicating a number of BWPs which take effect at the same time.

Optionally, in some embodiments, the method further includes: the network device sends at least one kind of configuration information in the Bandwidth Part (BWP) indication information, the BWP timer, and the BWP priority to a terminal device.

Method embodiments of the present application are described in detail above with reference to FIGS. 2 to 9, apparatus embodiments of the present application are described in detail below with reference to FIGS. 10 to 13. It should be understood that the apparatus embodiments and the method embodiments correspond to each other, and description of the method embodiments may be referred to for similar description of the apparatus embodiments.

FIG. 10 shows a block diagram of a terminal device 400 according to an embodiment of the present application. As shown in FIG. 10, the terminal device 400 includes a determining module 410 and a communication module 420.

The determining module 410 is configured to determine a target Bandwidth Part (BWP) according to at least one of BWP indication information, a BWP timer, and a BWP priority; and the communication module 420 is configured to transmit data on the target BWP.

Optionally, in some embodiments, the determining module 410 is specifically configured to: determine a BWP with a higher priority as the target BWP.

Optionally, in some embodiments, the BWP priority is determined by at least one of signaling configuration and a receiving order of the BWP indication information and priority configuration of a channel in which the BWP indication information is located.

Optionally, in some embodiments, a default BWP has a lowest priority.

Optionally, in some embodiments, configuration of the BWP timer includes at least one of a specific time length, a specific time pattern, a data transmission duration, and an infinite duration.

Optionally, in some embodiments, the data transmission duration is a duration of one time of data transmission or a duration of semi-persistent scheduling.

Optionally, in some embodiments, the BWP timer is exclusive to a BWP or independently configured.

Optionally, in some embodiments, the BWP timer is determined by at least one of a state of BWP configuration and a scheduling type.

Optionally, in some embodiments, a state of the BWP configuration is used for indicating a number of BWPs which take effect at the same time.

Optionally, in some embodiments, the communication module 420 is further configured to: receive at least one kind of configuration information in the Bandwidth Part (BWP) indication information, the BWP timer, and the BWP priority.

It should be understood that the terminal device 400 according to an embodiment of the present application may correspond to the terminal device in the method embodiment of the present application, and the above-mentioned and other operations and/or functions of various units in the terminal device 400 are respectively for realizing the corresponding processes of the terminal device in the method 200 shown in FIG. 2, and this will not be repeated here for sake of conciseness.

FIG. 11 is a schematic block diagram of a network device according to an embodiment of the present application. A network device 500 in FIG. 11 includes a determining module 510 and a communication module 520.

The determining module 510 is configured to determine a target Bandwidth Part (BWP) according to at least one of BWP indication information, a BWP timer, and a BWP priority; and the communication module 520 is configured to receive data on the target BWP.

Optionally, in some embodiments, the determining module 410 is specifically configured to: determine a BWP with a higher priority as the target BWP.

Optionally, in some embodiments, the BWP priority is determined by at least one of signaling configuration and a receiving order of the BWP indication information and priority configuration of a channel in which the BWP indication information is located.

Optionally, in some embodiments, a default BWP has a lowest priority.

Optionally, in some embodiments, configuration of the BWP timer includes at least one of a specific time length, a specific time pattern, a data transmission duration, and an infinite duration.

Optionally, in some embodiments, the data transmission duration is a duration of one time of data transmission or a duration of semi-persistent scheduling.

Optionally, in some embodiments, the BWP timer is exclusive to a BWP or independently configured.

Optionally, in some embodiments, the BWP timer is determined by at least one of a state of BWP configuration and a scheduling type.

Optionally, in some embodiments, a state of the BWP configuration is used for indicating a number of BWPs which take effect at the same time.

Optionally, in some embodiments, the communication module 520 is further used for: send at least one kind of configuration information in the Bandwidth Part (BWP) indication information, the BWP timer, and the BWP priority to a terminal device.

Specifically, the network device 500 may correspond to (e.g., may be configured in or be itself) the network device described in the method 300, and various modules or units in the network device 500 are respectively used for executing various actions or processes performed by the network device in the method 300. Herein, in order to avoid redundancy, detailed description thereof is omitted.

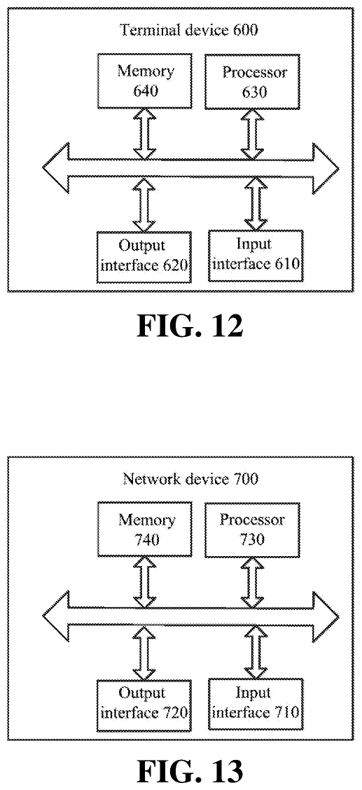

As shown in FIG. 12, the embodiment of the present application provides a terminal device 600, which may be the terminal device 400 in FIG. 10 and can be used for executing the operations of the terminal device corresponding to the method 200 in FIG. 2. The terminal device 600 includes an input interface 610, an output interface 620, a processor 630, and a memory 640. The input interface 610, the output interface 620, the processor 630, and the memory 640 may be connected through a bus system. The memory 640 is used for storing programs, instructions, or codes. The processor 630 is used for executing programs, instructions, or codes in the memory 640 to control the input interface 610 to receive signals, to control the output interface 620 to send signals, and to complete the operations in the foregoing method embodiments.

It should be understood that in the embodiments of the present application, the processor 630 may be a Central Processing Unit (CPU), or the processor 630 may be another general processor, digital signal processor (DSP), application specific integrated circuits (ASIC), field programmable gate arrays (FPGA) or another programmable logic device, discrete gate or transistor logic device, discrete hardware components, etc. The general processor may be a microprocessor, or the processor may be any conventional processor or the like.

The memory 640 may include a read only memory and a random access memory, and provide instructions and data to the processor 630. A portion of memory 640 may include non-transitory random access memory. For example, the memory 640 may store information of a device type.

In implementation processes, various contents of the methods described above may be accomplished by integrated logic circuits of hardware or instructions in the form of software in the processor 630. The contents of the method disclosed in connection with the embodiments of the present application may be directly embodied to be accomplished by an execution of the hardware processor or by the combination of hardware and software modules in the processor. The software modules may be located in a storage medium commonly used in the art, such as a random access memory, a flash memory, a read-only memory, a programmable read-only memory, or an electrically erasable programmable memory, or a register. The storage medium is located in the memory 640, and the processor 630 reads information in the memory 640 and completes the contents of the above method in combination with its hardware. In order to avoid repetition, it will not be described in detail here.

In a specific implementation, the communication module 420 included in the terminal device 400 in FIG. 10 may be implemented by the input interface 610 and the output interface 620 in FIG. 12, and the determining module 410 included in the terminal device 400 in FIG. 10 may be implemented by the processor 630 in FIG. 12.

As shown in FIG. 13, an embodiment of the present application provides a network device 700, wherein the network device 700 may be the network device 500 in FIG. 11, which can be configured to execute contents of the network device corresponding to the method 300 in FIG. 9. The network device 700 includes an input interface 710, an output interface 720, a processor 730, and a memory 740. The input interface 710, the output interface 720, the processor 730, and the memory 740 may be connected through a bus system. The memory 740 is used for storing programs, instructions, or codes. The processor 730 is used for executing programs, instructions, or codes in the memory 740 to control the input interface 710 to receive signals, to control the output interface 720 to send signals, and to complete the operations in the foregoing method embodiments.

It should be understood that in the embodiment of the present application, the processor 730 may be a Central Processing Unit (CPU), or the processor 730 may be another general processor, digital signal processor (DSP), application specific integrated circuits (ASIC), field programmable gate arrays (FPGA) or another programmable logic device, discrete gate or transistor logic device, discrete hardware components, etc. The general processor may be a microprocessor, or the processor may be any conventional processor or the like.

The memory 740 may include a read only memory and a random access memory, and provide instructions and data to the processor 730. A portion of memory 740 may include non-transitory random access memory. For example, the memory 740 may store information of a device type.

In implementation processes, various contents of the methods described above may be accomplished by integrated logic circuits of hardware or instructions in the form of software in the processor 730. The contents of the method disclosed in connection with the embodiments of the present application may be directly embodied to be accomplished by an execution of the hardware processor or by the combination of hardware and software modules in the processor. The software modules may be located in a storage medium commonly used in the art, such as a random access memory, a flash memory, a read-only memory, a programmable read-only memory, or an electrically erasable programmable memory, or a register. The storage medium is located in the memory 740, and the processor 730 reads information in the memory 740 and completes the contents of the above method in combination with its hardware. In order to avoid repetition, it will not be described in detail here.

In a specific embodiment, the communication module 520 included in the network device 500 in FIG. 11 may be implemented by the input interface 710 and the output interface 720 in FIG. 13, and the determining module 510 included in the network device 500 in FIG. 11 may be implemented by the processor 730 in FIG. 13.

An embodiment of the present application provides a computer readable storage medium that stores one or more programs including instructions, when the instructions are executed by a portable electronic device including multiple application programs, the portable electronic device is caused to perform the method of the embodiments shown in FIGS. 2 and 9.

An embodiments of the present application provides a computer program, which includes instructions, when the instructions are executed by a computer, the computer is caused to execute the corresponding processes of the method of the embodiments shown in FIGS. 2 and 9.

Those of ordinary skill in the art will recognize that the example elements and algorithm acts described in combination with the embodiments disclosed herein can be implemented in electronic hardware, or a combination of computer software and electronic hardware. Whether these functions are implemented in hardware or software depends on the specific application and design constraints of the technical solution. Skilled artisans may use different methods to implement the described functions in respect to each particular application, but such implementation should not be considered to be beyond the scope of the present application.

Those skilled in the art may clearly understand that for convenience and conciseness of description, the specific working processes of the systems, apparatuses and units described above may refer to the corresponding processes in the method embodiments and will not be described here.

In several embodiments provided by the present application, it should be understood that the disclosed systems, apparatuses and methods may be implemented in other ways. For example, the apparatus embodiments described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interfaces, apparatuses or units, and may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the purpose of the embodiments.

In addition, various functional units in various embodiments of the present application may be integrated in one processing unit, or the various units may be physically present separately, or two or more units may be integrated in one unit.

The functions may be stored in a computer readable storage medium if realized in a form of software functional units and sold or used as a separate product. Based on this understanding, the technical solution of the present application, in essence, or the part contributing to the prior art, or the part of the technical solution, may be embodied in the form of a software product stored in a storage medium, including a number of instructions for causing a computer device (which may be a personal computer, a server, or a network device) to perform all or part of the acts of the method described in various embodiments of the present application. The aforementioned storage medium include a medium capable of storing program codes, such as a U disk, a mobile hard disk, a read-only memory (ROM), a random access memory (RAM), a magnetic disk, or an optical disk.

What are described above are merely example embodiments of the present application, but the protection scope of the present application is not limited thereto. Any variation or substitution that may be easily conceived by a person skilled in the art within the technical scope disclosed by the present application shall be included within the protection scope of the present application. Therefore, the protection scope of the present application shall be determined by the protection scope of the claims.

1. A method for transmitting data, comprising:
determining, by a terminal device, a target Bandwidth Part (BWP) according to at least one of BWP indication information, a BWP timer, or a BWP priority; and
transmitting, by the terminal device, data on the target BWP.

2. The method according to claim 1, wherein determining, by the terminal device, the target Bandwidth Part (BWP) according to the at least one of BWP indication information, the BWP timer, or the BWP priority, comprises:
determining, by the terminal device, a BWP with a higher priority as the target BWP.

3. The method according to claim 1, wherein the BWP priority is determined by at least one of signaling configuration or a receiving order of the BWP indication information and priority configuration of a channel in which the BWP indication information is located.

4. The method according to claim 1, wherein a default BWP has a lowest priority.

5. The method according to claim 1, wherein configuration of the BWP timer comprises at least one of a specific time length, a specific time pattern, a data transmission duration, or an infinite duration.

6. The method according to claim 5, wherein the data transmission duration is a duration of one time of data transmission or a duration of semi-persistent scheduling.

7. The method according to claim 1, wherein the BWP timer is exclusive to a BWP or independently configured.

8. The method according to claim 1, wherein the BWP timer is determined by at least one of a state of BWP configuration or a scheduling type.

9. The method according to claim 8, wherein the state of the BWP configuration is used for indicating a number of BWPs which take effect at the same time.

10. The method according to claim 1, further comprising:
receiving, by the terminal device, configuration information of at least one of the BWP indication information, the BWP timer, or the BWP priority.

11-20. (canceled)

21. A terminal device, comprising:
a processor, configured to determine a target Bandwidth Part (BWP) according to at least one of BWP indication information, a BWP timer, or a BWP priority; and
a communication interface, configured to transmit data on the target BWP.

22. The terminal device according to claim 21, wherein the processor is further configured to:
determine a BWP with a higher priority as the target BWP.

23. The terminal device according to claim 21, wherein the BWP priority is determined by at least one of signaling configuration or a receiving order of the BWP indication information and priority configuration of a channel in which the BWP indication information is located.

24. The terminal device according to claim 21, wherein a default BWP has a lowest priority.

25. The terminal device according to claim 21, wherein configuration of the BWP timer comprises at least one of a specific time length, a specific time pattern, a data transmission duration, or an infinite duration.

26. The terminal device according to claim 25, wherein the data transmission duration is a duration of one time of data transmission or a duration of semi-persistent scheduling.

27. The terminal device according to claim 21, wherein the BWP timer is exclusive to a BWP or independently configured.

28. The terminal device according to claim 21, wherein the BWP timer is determined by at least one of a state of BWP configuration and or a scheduling type.

29. The terminal device according to claim 28, wherein the state of the BWP configuration is used for indicating a number of BWPs which take effect at the same time.

30. The terminal device according to claim 21, wherein the communication interface is further configured to:
receive configuration information of at least one of the Bandwidth Part (BWP) indication information, the BWP timer, or the BWP priority.

31-40. (canceled)
